(19) United States
(12) Patent Application Publication
(10) Pub. No.: US 2018/0174143 A1
(43) Pub. Date: Jun. 21, 2018

(54) DIFFERENTIAL COMMIT TIME IN A BLOCKCHAIN

(71) Applicant: International Business Machines Corporation, Armonk, NY (US)

(72) Inventors: Paul R. Bastide, Boxford, MA (US); Jonathan Dunne, Waterford (IE); Liam Harpur, Dublin (IE); Sumit Patel, Irving, TX (US)

(21) Appl. No.: 15/383,484

(22) Filed: Dec. 19, 2016

(51) Int. Cl. G06Q 20/40; G06Q 20/12; H04L 9/06; H04L 9/32

(52) U.S. Cl. CPC G06Q 20/405; G06Q 20/4016; H04L 2209/56; H04L 9/0637; H04L 9/32; G06Q 20/12

(57) ABSTRACT

A blockchain of transactions may be referenced for various purposes and may be later accessed by interested parties for ledger verification. One example method of operation may include one or more of identifying a blockchain transaction including a buyer and a seller and a product or service, identifying one or more attributes of the blockchain transaction, initializing a sale commit time window assigned to the blockchain transaction based on the one or more attributes, and committing the blockchain transaction to a blockchain when the sale commit time window has elapsed.

### Technical Field

This application relates to using a blockchain to store transactions, and more particularly, to differential commit time in a blockchain.

### BACKGROUND

Crypto-currencies and associated transactions have a number of significant disadvantages. For example, transactions are irreversible and can only be refunded by a person receiving funds. As such, there is no recourse if payment or product is sent to the wrong address or to an untrusted vendor. If an e-wallet or another crypto-currency fund source is hacked, the loss is the owner's responsibility. Therefore, what is needed is an ability for users to customize an acceptance, payment and product arrival based on their wants and needs.

### SUMMARY

One example embodiment may include a method that comprises one or more of identifying a blockchain transaction including a buyer and a seller and a product or service, identifying one or more attributes of the blockchain transaction, initializing a sale commit time window assigned to the blockchain transaction based on the one or more attributes, and committing the blockchain transaction to a blockchain when the sale commit time window has elapsed.

Another example embodiment may include an apparatus including a processor configured to perform one or more of identify a blockchain transaction including a buyer and a seller and a product or service, identify one or more attributes of the blockchain transaction, initialize a sale commit time window assigned to the blockchain transaction based on the one or more attributes, and commit the blockchain transaction to a blockchain when the sale commit time window has elapsed.

Still another example embodiment may include a non-transitory computer readable storage medium configured to store instructions that when executed cause a processor to perform one or more of identifying a blockchain transaction including a buyer and a seller and a product or service, identifying one or more attributes of the blockchain transaction, initializing a sale commit time window assigned to the blockchain transaction based on the one or more attributes, and committing the blockchain transaction to a blockchain when the sale commit time window has elapsed.

### BRIEF DESCRIPTION OF THE DRAWINGS

FIG. 1 illustrates a transaction network to perform a transaction analysis and commit decision according to example embodiments.

FIG. 2 illustrates a blockchain-based system procedure diagram of establishing commit criteria for a product transaction according to example embodiments.

FIG. 3A illustrates a flow diagram of an example method of determining commit criteria for a blockchain transaction according to example embodiments.

FIG. 3B illustrates a flow diagram of another example method of determining commit criteria for a blockchain transaction according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide establishing a commit schedule or decision that does not permit the committal of a transaction in a blockchain until a predetermined amount of time and/or criteria has been established. Further embodiments provide differentially determining commit criteria of a blockchain transaction based on behaviors and attributes associated with a transaction. Examples of transaction attributes may include, a type of service, a type of product, buyer history (e.g., rating, number of transactions, average price per transaction, status, type or transaction, etc.), seller history (e.g., rating, number of transactions, average price per transaction, status, type of transaction, etc.), price of product/service, location of product/service, location of buyer, etc. Each transaction should have a differentially processed commit time during which one or more of the parties or third parties (e.g., credit services, banks, financial institutions, etc.) may revoke the purchase/sale, and receive a refund or small penalty for withdrawing the transaction.

A blockchain transaction should not be committed (i.e., written to the blockchain) during the commit time but after the commit time has expired unless one or more of the qualifying parties has specifically accelerated/waived the commit time. In this example, if both parties agree to accelerate the commit time then the transaction may be finalized if all interested parties agree to do so, which in some cases may include the buyer, seller and the financial institution. The characteristics of the transaction may dynamically set a commit time window for each transaction whether it consist of seconds, years, or any time frame in-between. The blockchain will not commit after the end of the time when a cancellation has occurred. Except for any manual intervention or exception policy, the financial transaction waiting period should be initiated.

When determining a transaction time frame, a pattern analysis and data processing platform may determine a financial safety quotient which describes a sensitivity level of one or more of the parties to the transaction. When presenting the commit time (which may be automatically determined) to the transaction parties, adding, as part of the commit, a “reason” checksum to the ledger to denote the details of the transaction may also be desirable. This reason may be logged prior to any committed transaction so even if the transaction fails, the purpose is established for future reference purposes. In operation, the shared commit agreement may be in the form of smart contract and may cause a transaction to be committed to the blockchain upon expiration of the time window for that transaction.

In operation, financial transactions are provided into a system or the platform, incorporating information, such as a user ID, amount, product/service purchased, transaction time, purchase category, profile information, etc. Client-side monitoring is enabled to ascertain proximate activity for the financial transaction, such as correlation of the transaction to a related activity (e.g., research undertaken, communication on a topic, etc.). If client side monitoring is not available for the specified user, then a representative sample from an available social network can be used to ascertain the likely value. The financial safety quotient may be referred to as a risk quotient. For example, a transaction is riskier if a purchase for an item valued at a high dollar value occurs versus an item which is valued at a lower dollar value which is deemed to be less risky. The sellers and buyers would have a risk quotient that analyzes the item type in order to generate a relative risk quotient.

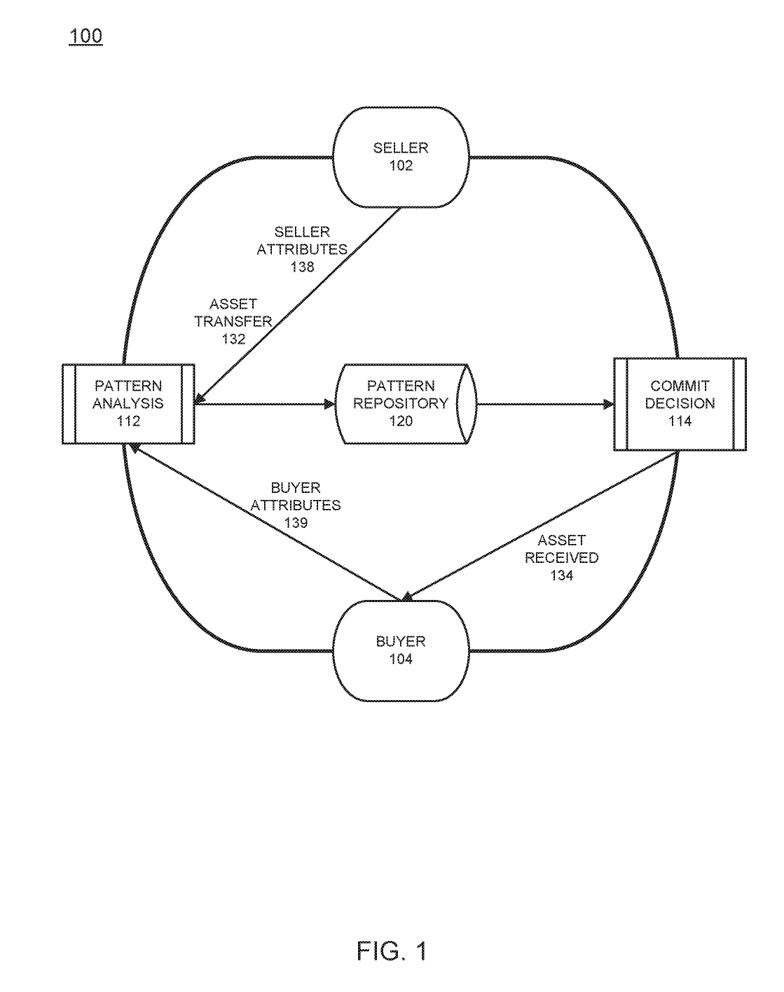

FIG. 1 illustrates a transaction network to perform a transaction analysis and commit decision according to example embodiments. Referring to FIG. 1, the buyer/seller network 100 illustrates a seller or seller computer 102 and a buyer or buyer computer 104 as entities participating in a blockchain network. The buyer 104 is willing to buy a product from the seller 102. The seller 102 may be a small entity or large-scale sales website. The sale of a product or service triggers a response from a pattern analysis application located on a computer 112 based on pattern data stored in a repository 120, which may be located on the computer or another computer. Any of the buyer/seller/product attributes may be referenced and used to determine a particular commit criteria for the transaction. The commit criteria may be more than just a time window during which the transaction is not written to the blockchain ledger. For example, the criteria may include funds being received by the seller prior to releasing the product and vice versa. Depending on the profile settings of the buyer/seller, the transaction may require more actions than just a specific time window where either party may withdraw from the transaction without penalty. In this example, the buyer attributes 138, the seller attributes 139, the asset attributes, etc., may all be requested and received by the pattern analysis application 112 prior to establishing a commit time. Once the asset is transferred 132, the commit time 114 can be established and a notification may be sent to all parties to the transaction prior to the asset being received 134 and the transaction being written to a blockchain.

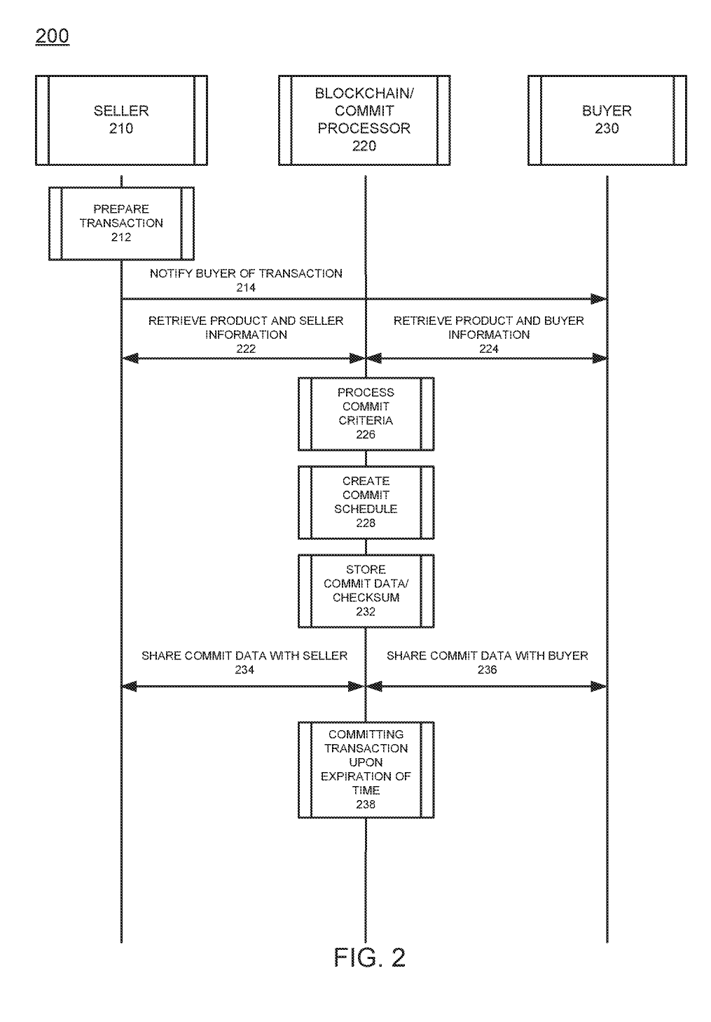

FIG. 2 illustrates a blockchain-based system procedure diagram of establishing commit criteria for a product transaction according to example embodiments. In this example, the system 200 includes a seller or seller computer 210, a buyer or buyer computer 230 and a blockchain/commit processor entity or computer 220, which may be more than one entity responsible for determining the commit transaction data, monitoring the commit time and writing the transaction to the blockchain. In this example, the seller 210 may prepare a transaction 212 by receiving a notification from a buyer or third party that a purchase has occurred or will occur. The buyer may be notified of the pending transaction 214 by the seller or a registered third party entity to the transaction. The commit processing entity may then attempt to retrieve transaction related attribute information 222 and 224 to customize a commit time and/or commit criteria for this transaction. The commit criteria 226 can then be processed to create a commit schedule 228 or time window. The commit data may be stored in a reason checksum 232 to enable a record for the pre-finalized transaction prior to any commitment of the transaction in the blockchain. The known commit data is then shared 234/236 with the seller 210 and buyer 230. The time displacement enables the finalization of the transaction 238 which includes identifying the time window has elapsed and committing the transaction to the blockchain provided it has not been cancelled.

In one embodiment, buyer and seller are permitted to dynamically change the sale time based on the characteristics of the transaction and the buyers and sellers (or users). For example, user ‘A’ may be unsure that user ‘B’ might be engaged in fraudulent activity. This dynamic commit time can be extended to enable profile based transactions with unique commit times (i.e., user ‘A’ has purchases which fall into different categories such as perishable raw materials or other types of materials). A financial safety quotient can be uniquely determined based on the purchasing/usage characteristics of each item creating two or more separate commit times. By adding such a differentiator, additional use cases are open to the possibility of utilizing the blockchain. Additional variables used to determine commit time may include, but are not limited to dates (i.e., items quick to spoil, such as food items), purchase details (i.e., gifts or purchases which occur around holidays can have longer commit times), or profile information including a buyer/seller rating. For example, user A's optimal commit time may be computed to be 3 days which may be different from other users' commit times. Transactions can be written at the end of each commit time.

In operation, a flow of financial transactions is provided into a system such as 100 or 200, incorporating information such as a user ID, an amount of a product/service bought, a transaction time, a purchase category, profile information, etc. Client side monitoring is also enabled to ascertain proximate activity for the financial transaction, such as correlation of the transaction to a related activity, such as research undertaken, communication on the topic, etc. If client side monitoring is not available for the specified user, then a representative sample from a social network may be used to ascertain the likely value. After a period of investigation (e.g., a number of weeks or months), from the above example, a financial safety quotient is ascertained which describes the involved party's sensitivity to the transaction. For example, user A does not normally purchase a certain item and the amount is above a likely threshold that the user considers to warrant additional financial safety measures.

This index of sensitivity may be maintained at the seller computer 210, the client computer 230, the computer 220 or any other computer. This index is also used to understand an optimal commit time from the perspective of the buyer and the seller. An automated system is used to identify an acceptable time for both parties. For example, if user A′s optimal commit time is computed to be in days and the seller prefers hours, then the system uses the existing information to understand if user ‘A’ or seller ‘B’ would accommodate the other party's commit time or have a compromise time that is likely to be acceptable to both parties.

Additionally, the index may use profile based information included as part of the transaction, for instance, a perishable item having a lower commit variance or as part of the buyer or seller record. For example, the buyer/seller rating indicating higher trust permits for greater commit time ranges. In one example, user ‘A’ indicates that item ‘X’ is to be bought for ‘Y’ amount. Based on the financial transaction information and the lookup against the database for the commit time, an automatic commit time is presented to the involved parties. Provided there is not any manual intervention or exception policy, the financial transaction waiting period can be initiated. Changes to the profile information for the buyer/seller or the purchase itself may proactively cause changes in the commit time (i.e., purchase parameters indicate an item will be consumed sooner so the commit time may be shortened). As part of the commit decision, the system can add a “reason” checksum to the ledger to denote the shared commit. For instance, a valid signature to authorize the transaction could be required and as part of an implementation it may involve the entering of additional information if the sensitivity of the transaction is high to guard against certain systems which could create threats. Upon validation (e.g., commit time expired), the transaction is checked into the common ledger. As part of an example implementation, the entering of information, if the sensitivity of the transaction is elevated, will protect against systems (such as high-speed buy/sell systems, for example) which could cause problems. To confirm that a human is generating the transaction and not an automated computer, an application (such as a CAPTCHA, for example) can be presented to confirm a human user and potentially confirm the user at the end of a transaction wanted the transaction rather than a timeout occurring.

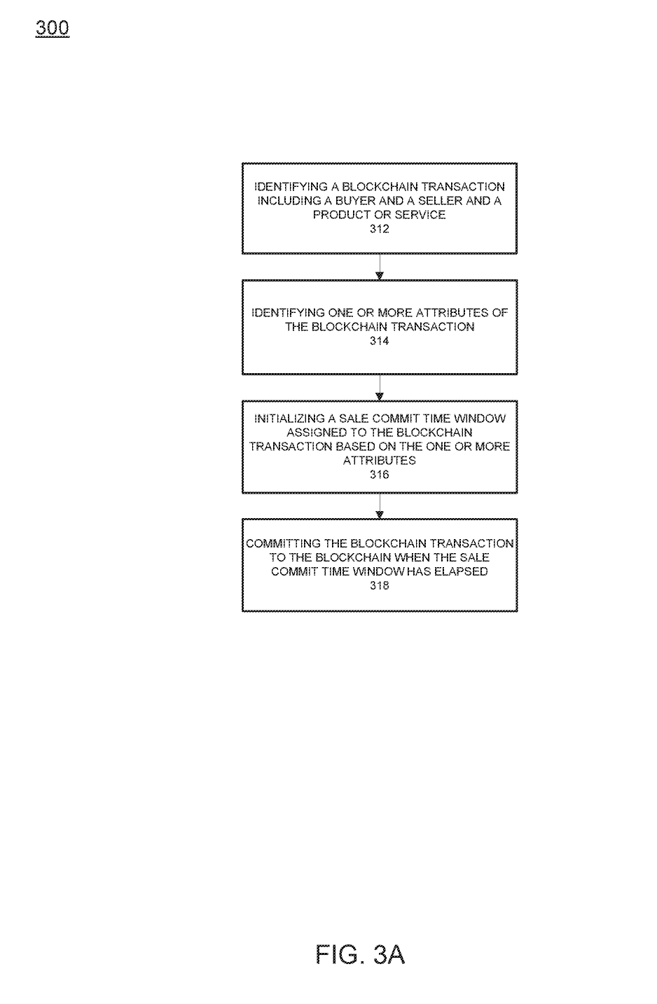

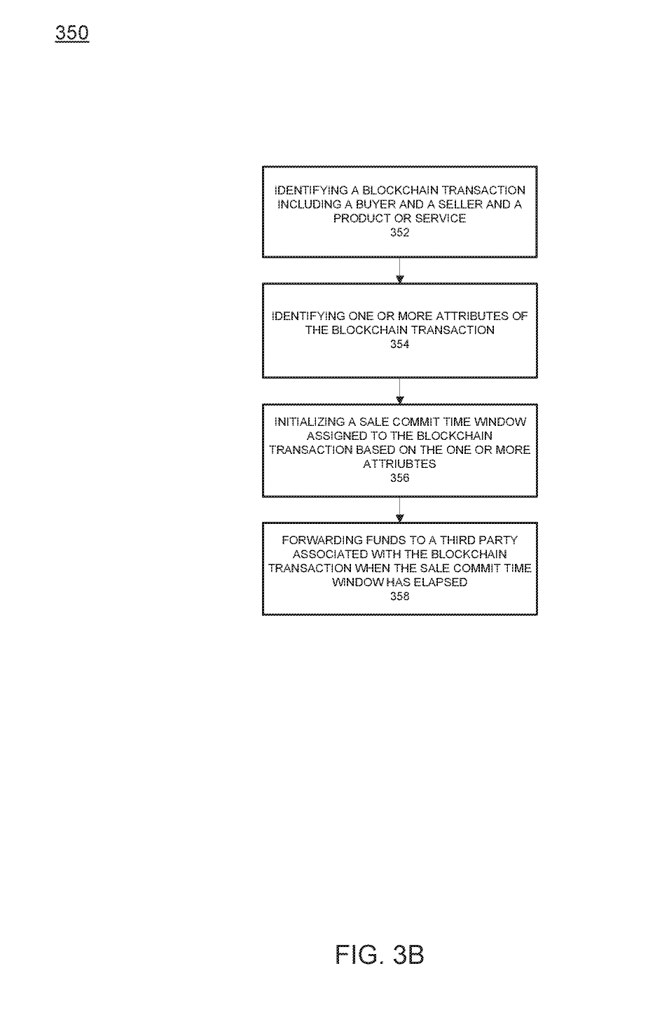

FIG. 3A illustrates a flow diagram 300 of an example method of determining commit criteria for a blockchain transaction according to example embodiments. Referring to FIG. 3A, the method may comprise one or more of identifying a blockchain transaction including a buyer and a seller and a product or service 312, identifying one or more attributes of the blockchain transaction 314, initializing a sale commit time window assigned to the blockchain transaction based on the one or more attributes 316, and committing the blockchain transaction to the blockchain when the sale commit time window has elapsed 318. The attributes can include one or more of a transaction history of the seller, a transaction history of the buyer, a purchase price, a shelf-life of the product, a gift status of the product or service, calendar dates associated with the purchase date, profile information of the buyer, and profile information of the seller. Also, the method may include determining a financial safety quotient function used to initialize the sale commit time and identifying the buyer or the seller is associated with a fraudulent blockchain transaction within the sale commit time window, and responsive to identifying the fraudulent blockchain transaction, cancelling the blockchain transaction prior to committing the blockchain transaction to the blockchain.

The method may also include identifying a time sensitive attribute with an expiration time within the sale commit time window, and responsive to identifying the time sensitive attribute, cancelling the blockchain transaction prior to committing the blockchain transaction to the blockchain. The method may also include retrieving a buyer profile or a seller profile of the buyer, identifying one or more of the attributes in the buyer profile or the seller profile which have changed since occurrence of the blockchain transaction, determining the sale commit time window requires an extension of time based on the one or more attributes identified in the buyer profile or the seller profile, and modifying the sale commit time window based on the required extension of time. Also, the method may also include adding a reason checksum to the blockchain to identify and authorize the sale commit time window.

FIG. 3B illustrates a flow diagram 350 of another example method of determining commit criteria for a blockchain transaction according to example embodiments. Referring to FIG. 3B, the method may comprise one or more of identifying a blockchain transaction including a buyer and a seller and a product or service 352, identifying one or more attributes of the blockchain transaction 354, initializing a sale commit time window assigned to the blockchain transaction based on the one or more attributes 356, and forwarding funds to a third party associated with the blockchain transaction when the sale commit time window has elapsed 358. In this example, the third party is a proxy or control party which holds the transaction funds in question until the commit time has elapsed. Therefore, the third party is just as notable to the transaction as the buyer and seller.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

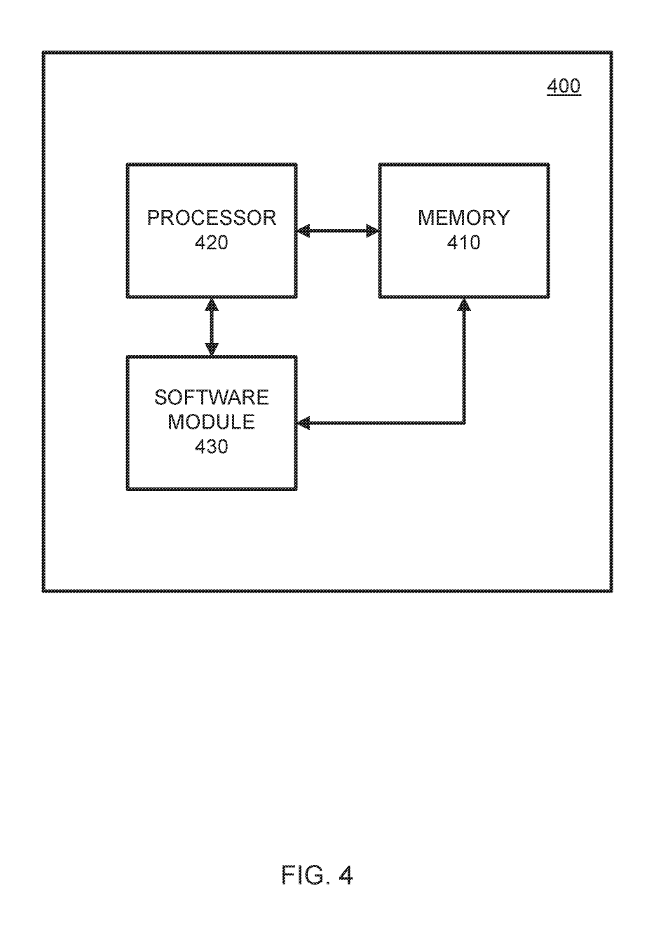

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 4 illustrates an example network element 400, which may represent or be integrated in any of the above-described components, etc.

As illustrated in FIG. 4, a memory 410 and a processor 420 may be discrete components of a network entity 400 that are used to execute an application or set of operations as described herein. The application may be coded in software in a computer language understood by the processor 420, and stored in a computer readable medium, such as, a memory 410. The computer readable medium may be a non-transitory computer readable medium that includes tangible hardware components, such as memory, that can store software. Furthermore, a software module 430 may be another discrete entity that is part of the network entity 400, and which contains software instructions that may be executed by the processor 420 to effectuate one or more of the functions described herein. In addition to the above noted components of the network entity 400, the network entity 400 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
identifying a blockchain transaction comprising a buyer and a seller and a product or service;
identifying one or more attributes of the blockchain transaction;
initializing a sale commit time window assigned to the blockchain transaction based on the one or more attributes; and
committing the blockchain transaction to a blockchain when the sale commit time window has elapsed.

2. The method of claim 1, wherein the one or more attributes comprise one or more of: a transaction history of the seller, a transaction history of the buyer, a purchase price, a shelf-life of the product, a gift status of the product or service, calendar dates associated with a purchase date, profile information of the buyer, and profile information of the seller.

3. The method of claim 1, further comprising determining a financial safety quotient function used to initialize a sale commit time.

4. The method of claim 1, further comprising:
identifying the buyer or the seller is associated with a fraudulent blockchain transaction within the sale commit time window; and
responsive to identifying the fraudulent blockchain transaction, cancelling the blockchain transaction prior to committing the blockchain transaction to the blockchain.

5. The method of claim 1, further comprising:
identifying a time sensitive attribute with an expiration time within the sale commit time window; and
responsive to identifying the time sensitive attribute, cancelling the blockchain transaction prior to committing the blockchain transaction to the blockchain.

6. The method of claim 1, further comprising:
retrieving a buyer profile or a seller profile of the buyer;
identifying one or more of the attributes in the buyer profile or the seller profile which have changed since occurrence of the blockchain transaction;
determining the sale commit time window requires an extension of time based on the one or more attributes identified in the buyer profile or the seller profile; and
modifying the sale commit time window based on the required extension of time.

7. The method of claim 1, further comprising adding a reason checksum to the blockchain to identify and authorize the sale commit time window.

8. An apparatus, comprising:
a processor configured to:
identify a blockchain transaction comprising a buyer and a seller and a product or service; identify one or more attributes of the blockchain transaction;
initialize a sale commit time window assigned to the blockchain transaction based on the one or more attributes; and
commit the blockchain transaction to a blockchain when the sale commit time window has elapsed.

9. The apparatus of claim 8, wherein the one or more attributes comprise one or more of: a transaction history of the seller, a transaction history of the buyer, a purchase price, a shelf-life of the product, a gift status of the product or service, calendar dates associated with a purchase date, profile information of the buyer, and profile information of the seller.

10. The apparatus of claim 8, wherein the processor is further configured to determine a financial safety quotient function used to initialize a sale commit time,

11. The apparatus of claim 8, wherein the processor is further configured to:
identify the buyer or the seller is associated with a fraudulent blockchain transaction within the sale commit time window; and
responsive to the fraudulent blockchain transaction being identified, cancel the blockchain transaction prior to the blockchain transaction being committed to the blockchain.

12. The apparatus of claim 8, wherein the processor is further configured to:
identify a time sensitive attribute with an expiration time within the sale commit time window; and
responsive to the time sensitive attribute being identified, cancel the blockchain transaction prior to the blockchain transaction being committed to the blockchain.

13. The apparatus of claim 8, wherein the processor is further configured to:
retrieve a buyer profile or a seller profile of the buyer;
identify one or more of the attributes in the buyer profile or the seller profile which have changed since occurrence of the blockchain transaction;
determine the sale commit time window requires an extension of time based on the one or more attributes identified in the buyer profile or the seller profile; and
modify the sale commit time window based on the required extension of time.

14. The apparatus of claim 8, wherein the processor is further configured to add a reason checksum to the blockchain to identify and authorize the sale commit time window.

15. A non-transitory computer readable storage medium configured to store instructions that when executed cause a processor to perform:
identify a blockchain transaction comprising a buyer and a seller and a product or service;
identify one or more attributes of the blockchain transaction;
initialize a sale commit time window assigned to the blockchain transaction based on the one or more attributes; and
commit the blockchain transaction to a blockchain when the sale commit time window has elapsed.

16. The non-transitory computer readable storage medium of claim 15, wherein the one or more attributes comprise one or more of: a transaction history of the seller, a transaction history of the buyer, a purchase price, a shelf-life of the product, a gift status of the product or service, calendar dates associated with a purchase date, profile information of the buyer, and profile information of the seller.

17. The non-transitory computer readable storage medium of claim 15, wherein the processor is further configured to perform determining a financial safety quotient function used to initialize a sale commit time.

18. The non-transitory computer readable storage medium of claim 15, wherein the processor is further configured to perform:
identifying the buyer or the seller is associated with a fraudulent blockchain transaction within the sale commit time window; and
responsive to identifying the fraudulent blockchain transaction, cancelling the blockchain transaction prior to committing the blockchain transaction to the blockchain.

19. The non-transitory computer readable storage medium of claim 15, wherein the processor is further configured to perform:
identifying a time sensitive attribute with an expiration time within the sale commit time window; and
responsive to identifying the time sensitive attribute, cancelling the blockchain transaction prior to committing the blockchain transaction to the blockchain.

20. The non-transitory computer readable storage medium of claim 15, wherein the processor is further configured to perform:
retrieving a buyer profile or a seller profile of the buyer;
identifying one or more of the attributes in the buyer profile or the seller profile which have changed since occurrence of the blockchain transaction;
determining the sale commit time window requires an extension of time based on the one or more attributes identified in the buyer profile or the seller profile;
modifying the sale commit time window based on the required extension of time; and
adding a reason checksum to the blockchain to identify and authorize the sale commit time window
